(19) United States
(12) Patent Application Publication
(10) Pub. No.: US 2022/0064919 A1
(43) Pub. Date: Mar. 3, 2022

(54) Handwashing Timer

(71) Applicant: KENN Innovations LLC, Melbourne, FL (US)

(72) Inventors: Nicholas S. Beber, Santa Cruz, CA (US); Elena N. Beber, Melbourne, FL (US); Kevin M. Beber, Melbourne, FL (US)

(21) Appl. No.: 17/009,835

(22) Filed: Sep. 2, 2020

(51) Int. Cl. E03C 1/05; E03C 1/046; E03C 1/04

(52) U.S. Cl. CPC E03C 1/055; E03C 1/0404; E03C 1/046

(57) ABSTRACT

A handwashing timer comprises a timer housing configured to be attached to a water faucet or a soap dispenser; a sensor housed within the timer housing and configured to detect an event; an output (e.g., an optical output, an acoustic output, a vibrational output) housed within or on the timer housing; and a controller housed within the timer housing, responsive to the sensor, and configured to measure a time from when the sensor detects the event and to change a state of the output after the measured time exceeds a threshold.

### FIELD OF THE INVENTION

The invention is generally related to timers with notifications, and more specifically, to a timer with notifications configured to attach to a faucet or soap dispenser combination to measure a recommended duration of time for handwashing and notify a user when the recommended duration has elapsed.

### BACKGROUND OF THE INVENTION

Health care professionals recommend that hands be washed for a minimum of twenty seconds or more. However, many people, especially children, fail to wash their hands for this recommended time. Conventional timers fail to provide a convenient mechanism for measuring an amount of time people spend washing their hands.

An improved mechanism for measuring and notifying a recommended duration of time for handwashing is needed.

### SUMMARY OF THE INVENTION

According to various implementations of the invention, a handwashing timer and notification system may be configured to attach to a water faucet and/or soap dispenser to measure a recommended duration of time for handwashing and to notify a user when the recommended duration has elapsed. In various implementations of the invention, the handwashing timer may be initiated when a user turns the water faucet on or dispenses soap from the soap dispenser; then, after the recommended duration of time for handwashing has elapsed, the handwashing timer provides a notification signal (e.g., an optical notification signal, a vibrational notification signal, an acoustic notification signal, or other notification signal) to indicate that the recommended duration of time has elapsed.

In some implementations of the invention, the handwashing timer may include a light that illuminates when the user turns the water faucet on and/or dispenses soap, and after the recommended duration of time for handwashing has elapsed, the light turns off. In some implementations of the invention, the handwashing timer may include a first-colored light that illuminates when the user turns the water faucet on and/or dispenses soap, and after the recommended duration of time for handwashing has elapsed, the first-colored light turns off and a second colored light illuminates. By way of example, and not of limitation, the first-colored light may be red and the second colored light may be green, though other colors may be used as would be apparent.

In some implementations of the invention, the timer and/or the light(s) may be turned off when the user turns the water faucet off. In some implementations, the timer and/or the light(s) may remain active if the user should turn the water faucet off while washing their hands, for example, in order to conserve water.

In some implementations of the invention, the handwashing timer may include a sensor (e.g., a water sensor, a flow sensor, a motion sensor, a proximity sensor, or other sensor) that detects when the user turns on the water faucet or dispenses soap. In some implementations of the invention, the sensor may detect when water begins flowing through a spout of the water faucet as would be appreciated. In some implementations of the invention, the sensor may detect when the user is proximate to or moving near the water faucet and/or a soap dispenser. In some implementations of the invention, the sensor may also serve to turn on the water faucet or dispense the soap in addition to initiating the timer as would be appreciated.

These and other features of the invention are described in detail below.

### BRIEF DESCRIPTION OF THE DRAWINGS

FIG. 1 illustrates a water faucet with a handwashing timer and notification system according to various implementations of the invention.

FIG. 2 illustrates a water faucet coupled to a handwashing timer according to various implementations of the invention.

FIG. 3 illustrates an electrical circuit for a handwashing timer according to various implementations of the invention.

FIG. 4 illustrates a state diagram for a handwashing timer according to various implementations of the invention.

FIG. 5 illustrates a state diagram for a handwashing timer according to various implementations of the invention.

FIG. 6 illustrates a state diagram for a handwashing timer according to various implementations of the invention.

### DETAILED DESCRIPTION

Various implementations of the invention are directed toward a handwashing timer and notification system. While various implementations of the invention are described herein in the context of a water faucet and washing hands, the invention is not so limited. For example, the following description is readily adapted to the context of a soap dispenser and washing hands as will become apparent from the following description. Other implementations of the invention may be adapted to timing other activities as will become apparent from the following description. Further, while various implementations of the invention are described in terms of turning on or off a light(s) as an optical notification to the user, the invention is not so limited. For example, the following description is readily adapted to using an acoustic notification, a vibrational notification, or other notification as will become apparent from the following description.

According to various implementations of the invention, the handwashing timer changes from an off light state to a first light state when a user turns on a water faucet, and changes to a second light state after a certain amount of time has elapsed with or without the water running. For example, in some implementations, a light of the handwashing timer turns on when water begins flowing from the water faucet, and then after a period of time elapses, the light may turn off. As another example, in some implementations of the invention, a first light of the handwashing timer turns on when water begins flowing from the water faucet, and then after a period of time elapses, a second light of the handwashing timer turns on. In some implementations, the first light and the second light have different colors from one another. In some implementations, the first light turns off when the second light turns on. Other configurations and operations of the light(s) of the handwashing timer may be used as would be appreciated. According to various implementations of the invention, the lights provide a notification to the user when a certain amount of time has elapsed since water began flowing from the water faucet.

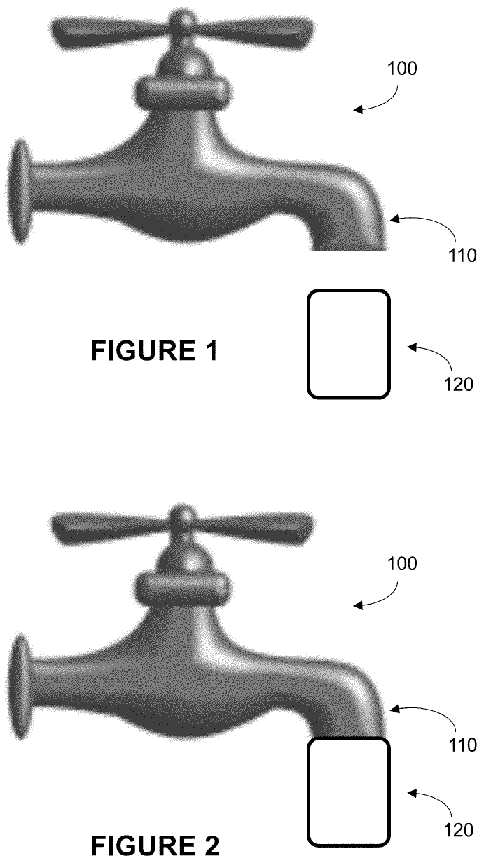

FIG. 1 illustrates a water faucet 100 with a spout 110. FIG. 1 also illustrates a handwashing timer 120 according to various implementations of the invention. FIG. 2 illustrates handwashing timer 120 installed on spout 110 of water faucet 100 according to various implementations of the invention.

Handwashing timer 120 may have a housing in which various components of handwashing timer 120 may be installed. In some implementations, housing may have an interior configured to receive spout 110. In some implementations, the interior of housing may be threaded to receive mating exterior threads on spout 110. In some implementations, housing may be friction fit over spout 110. In some implementations, the interior of housing may have a material (e.g., rubber, etc.) configured to friction fit over spout 110. In some implementations, housing may have an exterior configured to receive spout 110. In some implementations, the exterior of housing may be threaded to receive mating interior threads on spout 110. In some implementations, housing may friction fit inside spout 110. In some implementations, the exterior of housing may have a material (e.g., rubber, etc.) configured to friction fit over spout 110. In some implementations of the invention, housing may be configured to fit inside spout 110 in a manner similar to conventional faucet aerators or conventional faucet filters as would be appreciated. In some implementations, housing may be installed in locations on or proximate to faucet 100 other than on spout 110. In some implementations, housing may be installed in locations on or proximate to a sink rather than on or proximate to faucet 100.

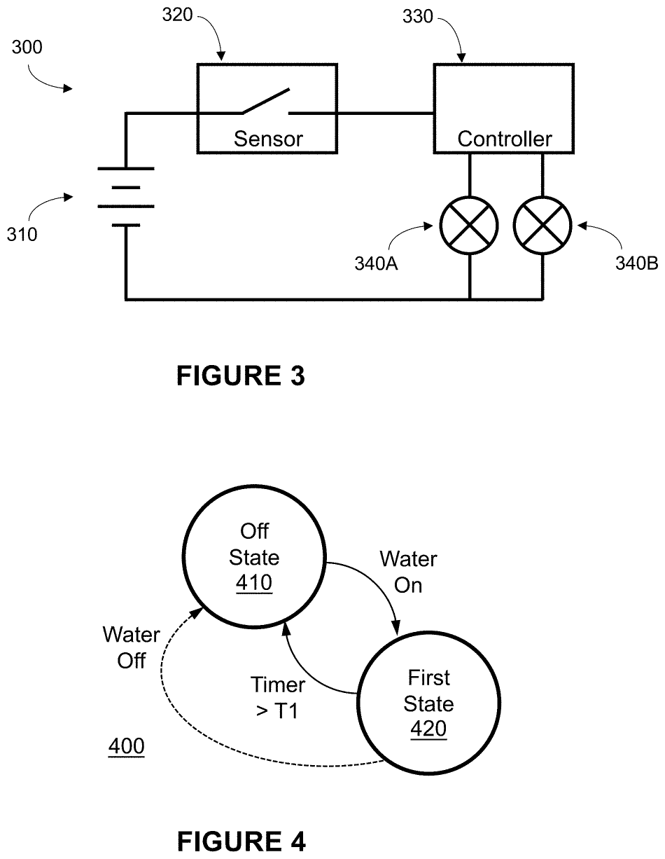

FIG. 3 illustrates an electrical circuit 300 for handwashing timer 120 according to various implementations of the invention. In some implementations of the invention, circuit 300 includes a sensor 320 (e.g., a water sensor, a flow sensor, etc.) configured to detect water flowing through spout 110. In some implementations of the invention, circuit 300 includes sensor 320 (e.g., a motion sensor, a proximity sensor, or other sensor) configured to detect proximity or motion of the user (e.g., the user's hands, arms, etc.) near water faucet 100 and/or spout 110; such sensor 320 may also be used to turn on water faucet 100 as would be appreciated. In some implementations of the invention, circuit 300 includes sensor 320 that detects a mechanical act of turning on water faucet 100 as would be appreciated. While sensor 320 is illustrated in FIG. 3 as a switch, sensor 320 may not function strictly as an electrical switch and instead, for example, function as a logical switch as would be appreciated.

In some implementations of the invention, circuit 300 includes a controller 330 responsive to sensor 320 and configured to control operation of various aspects of the invention. In some implementations of the invention, controller 330 controls one or more notifications or outputs 340 (illustrated in FIG. 3 as an output 340A, a output 340B, etc.). While the following description refers to output 340 as an optical output or a light 340, other types of outputs 340 may be used, such as but not limited to, an acoustic output, a vibrational output, or other output. In some implementations, each light 340 may include a single light or a plurality of lights as would be appreciated. In some implementations of the invention, each light 340 may include an array of LED lights as would be appreciated. In some implementations, each light 340 may include a colored light (i.e., a non-white light). In some implementations, lights 340 may include different colors from one another; for example, light 340A may have a color different from a color of light 340B. In some implementations, light 340A may be red and light 340B may be green. Light 340 may have other colors as would be appreciated. In some implementations of the invention, light 340 may be an LED light. In some implementations of the invention, light 340A and light 340B may be different colors of a single color-changing LED light (or array of LED lights) as would be appreciated.

In some implementations of the invention, light 340 is configured to illuminate an area outside the housing of handwashing timer 120. In some implementations of the invention, light 340 is configured to illuminate an area inside the housing of handwashing timer 120. In some implementations of the invention, light 340 is configured to illuminate areas inside and outside the housing of handwashing timer 120. In some implementations of the invention, light 340 is configured to illuminate water flowing from spout 110. In some implementations of the invention, light 340 may give water flowing from spout 110 an appearance of having a color as would be appreciated.

In some implementations of the invention, controller 330 may include a timer (not otherwise illustrated). In some implementations, the timer is configured to measure a time duration during which water flows from spout 110 (or more precisely, when sensor 320 detects some condition associated with such water). In some implementations, the timer is configured to measure a time beginning when water starts flowing from spout 110, whether or not water flows continuously from spout 110. In some implementations, the timer measures a fixed, predetermined amount of time as would be appreciated. In some implementations, the timer measures a selectable predetermined amount of time as would be appreciated. In some implementations, the timer measures an adjustable amount of time as would be appreciated. In some implementations, the timer is set to measure a threshold amount of time for a specific recommended activity, such as a recommended duration for washing hands.

FIG. 4 illustrates a state diagram 400 for handwashing timer 120 according to various implementations of the invention. As would be appreciated, in some implementations of the invention, controller 330 may be configured to operate in accordance with state diagram 400. In some implementations of the invention, controller 330 may transition from an off state 410 to a first state 420 when water begins flowing from spout 110 (e.g., as detected by sensor 320). In some implementations of the invention, when controller 330 enters first state 420, controller 330 may activate the timer and may activate light 340. In some implementations of the invention, controller 330 may transition from first state 420 to off state 410 after the timer reaches or exceeds a threshold time, T1. In some implementations of the invention, when returning to off state 410, controller 330 may deactivate the timer and may deactivate light 340. In various optional implementations of the invention, controller 330 may also transition from first state 420 to off state 410 when water ceases flowing from spout 110 (e.g., as detected by sensor 320).

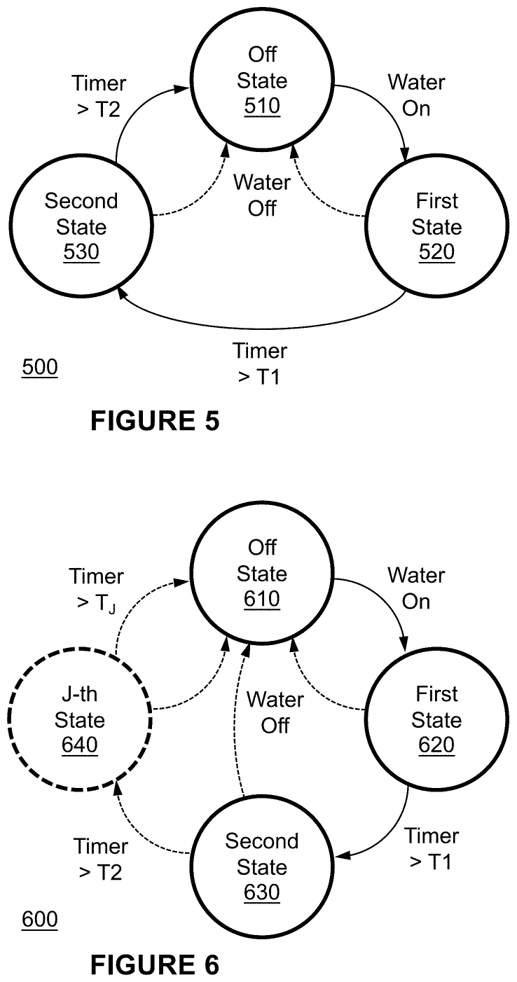

FIG. 5 illustrates a state diagram 500 for handwashing timer 120 according to various implementations of the invention. As would be appreciated, in some implementations of the invention, controller 330 may be configured to operate in accordance with state diagram 500. In some implementations of the invention, controller 330 may transition from an off state 510 to a first state 520 when water begins flowing from spout 110 (e.g., as detected by sensor 320). In some implementations of the invention, when controller 330 enters first state 520, controller 330 may activate the timer and may activate light 340A. In some implementations of the invention, controller 330 may transition from first state 520 to a second state 530 after the timer reaches or exceeds a threshold time, T1. In some implementations of the invention, when controller 330 enters second state 530, controller 330 may deactivate the timer and may activate light 340B. In some implementations of the invention, when controller 330 enters second state 530, controller 330 may deactivate the timer, may deactivate light 340A, and may activate light 340B. In some implementations of the invention, when controller 330 enters second state 530, controller 330 may reactivate the timer (or may activate a second timer) to measure a threshold time, T2. In some implementations of the invention, controller 330 may transition from second state 530 to off state 510 after the timer reaches or exceeds the threshold time, T2. In some implementations, threshold time, T1, and threshold time, T2 are the same; and in other implementations, threshold time, T1, and threshold time, T2 are different. In various optional implementations of the invention, controller 330 may also transition from first state 520 to off state 510, and/or transition from second state 530 to off state 510, when water ceases flowing from spout 110 (e.g., as detected by sensor 320).

FIG. 6 illustrates a state diagram 600 for handwashing timer 120 according to various implementations of the invention. As would be appreciated, in some implementations of the invention, controller 330 may be configured to operate in accordance with state diagram 600. In some implementations of the invention, controller 330 may transition from an off state 610 to a first state 620 when water begins flowing from spout 110 (e.g., as detected by sensor 320). In some implementations of the invention, when controller 330 enters first state 620, controller 330 may activate the timer and may activate light 340A. In some implementations of the invention, controller 330 may transition from first state 620 to a second state 630 after the timer reaches or exceeds a threshold time, T1. In some implementations of the invention, when controller 330 enters second state 630, controller 330 may deactivate the timer and may activate light 340B. In some implementations of the invention, when controller 330 enters second state 630, controller 330 may deactivate the timer, may deactivate light 340A, and may activate light 340B. In some implementations of the invention, when controller 330 enters second state 630, controller 330 may reactivate the timer (or may activate a second timer) to measure a threshold time, T2. In some implementations of the invention, controller 330 may transition from second state 630 to a J-th state 640 after the timer reaches or exceeds the threshold time, T2. In some implementations of the invention, when controller 330 enters J-th state 640, controller 330 may deactivate the timer and may activate a J-th light (not otherwise illustrated). In some implementations of the invention, when controller 330 enters J-th state 640, controller 330 may deactivate the timer, may deactivate light 340B, and may activate the J-th light. In some implementations of the invention, when controller 330 enters J-th state 640, controller 330 may reactivate the timer (or may activate a J-th timer) to measure a threshold time, T_{J}. In some implementations, threshold time, T2, and threshold time, T_{J} are the same; and in other implementations, threshold time, T1, and threshold time, T_{J} are different. In various optional implementations of the invention, controller 330 may also transition from first state 620 to off state 610, and/or transition from second state 630 to off state 610, and/or transition from J-th state 640 to off state 610, when water ceases flowing from spout 110 (e.g., as detected by sensor 320).

While various implementations of the invention are described in connection with sensor 320 detecting “water flow” to initiate some transitions in state diagrams 400, 500, 600, other implementations of the invention may rely on sensor 320 to detect motion of the user (e.g., motion of the user's hands proximate to water faucet 100 or spout 110) to initiate such transitions as would be appreciated.

While lights 340 are described as having different colors in various implementations of the invention, lights 340 may have different blinking patterns instead of, or in addition to, colors. For example, lights 340 may blink during one state and lights 340 may remain steady during another state. Other patterns or combinations of blinking patterns may be used as would be appreciated.

While controller 330 is described as controlling lights 340, controller 330 may control other output devices as would be appreciated. For example, lights 340 may be replaced with, or operate in connection with acoustic devices including, but not limited to, speakers, buzzers, alarms, bells, or other acoustic devices as would be appreciated. Such acoustic devices may further include a recording including speech, music, and/or a song.

While handwashing timer 120 is described in relation to water faucet 100, other implementations of the invention incorporate handwashing timer 120 into a soap dispenser. In these implementations, operation of handwashing timer 120 is based on dispensing of soap from the soap dispenser rather than water flowing from water faucet 100 as would be appreciated.

While various implementations of the invention are described relative to hand washing, other implementations of the invention may be applied to taking showers and the thresholds for the timer are adjusted accordingly. For example, thresholds for children may be set to indicate when the child has spent a sufficient time in the shower; whereas thresholds for teenagers may be set to indicate when the teenager has spent too long a time in the shower. Other thresholds may be used for other notification purposes as would be appreciated.

What is claimed:

1. A handwashing timer comprising:
a timer housing configured to be attached to a water faucet or a soap dispenser;
a sensor housed within the timer housing and configured to detect when the water faucet is turned on or when the soap dispenser dispenses soap;
an output housed within or on the timer housing, wherein the output comprises an optical output, an acoustic output, or a vibrational output; and
a controller housed within the timer housing, responsive to the sensor, and configured to measure a time beginning when the water faucet is turned on or when the soap dispenser dispenses soap and to change a state of the output after the measured time exceeds a threshold.

2. The handwashing timer of claim 1, wherein the output is the optical output and wherein the optical output comprises a plurality of lights.

3. The handwashing timer of claim 1, wherein the output is the optical output and wherein the optical output comprises a light having a plurality of different selectable colors.

4. The handwashing timer of claim 1, wherein the output is the optical output and wherein the optical output comprises a plurality of lights, each with a plurality of different selectable colors.

5. The handwashing timer of claim 1, wherein the output is the optical output and wherein the optical output comprises a plurality of different colored lights.

6. The handwashing timer of claim 1, wherein the controller comprises a timer.

7. The handwashing timer of claim 1, wherein the output is the optical output and wherein the optical output is configured to illuminate the water flowing from the spout.

8. The handwashing timer of claim 1, wherein the controller is further configured to change a state of the output after the water begins to flow or the soap is dispensed.

9. A handwashing timer comprising:
a timer housing configured to be attached to a water faucet or a soap dispenser;
a sensor housed within the timer housing and configured to detect an event, wherein the event is either when the water faucet is turned on or when the soap dispenser dispenses soap;
an output housed within or on the timer housing; and
a controller housed within the timer housing, responsive to the sensor, configured to measure a time from when the sensor detects the event, configured to change the output to a first state when the sensor detects the event, and configured to change the output to a second state when the measured time exceeds a threshold.

10. The handwashing timer of claim 9, wherein the controller configured to change the output to a first state comprises turning the output on, and wherein the controller configured to change the output to a second state comprises turning the output off.

11. The handwashing timer of claim 9, wherein the output is a light and wherein the controller configured to change the output to a first state comprises turning the light to a first color, and wherein the controller configured to change the output to a second state comprises turning the light to a second color different from the first color.

12. The handwashing timer of claim 9, wherein the output is a light, wherein the light comprises a plurality of lights, and wherein the controller configured to change the output to a first state comprises turning a first subset of the plurality of lights on, wherein the controller configured to change the output to a second state comprises turning a second subset of the plurality of lights on, wherein the first subset of the plurality of lights is different from the second subset of the plurality of lights.

13. The handwashing timer of claim 12, wherein the output is a light and wherein the controller configured to change the output to a second state comprises turning the first subset of the plurality of lights off.

14. The handwashing timer of claim 12, wherein the first subset of the plurality of lights has a color different from a color of the second subset of the plurality of lights.
